(19) United States
(12) Patent Application Publication
(10) Pub. No.: US 2012/0098267 A1
(43) Pub. Date: Apr. 26, 2012

(54) Pump storage arrangement, method of operating a pump storage arrangement and pump storage hydropower plant

(75) Inventors: Juergen Hockenberger, Eppingen-Elsenz (DE); Bernhard Dudenhoeffer, Herxheim (DE)

(73) Assignee: Sulzer Pumpen (Deutschland) GmbH, Bruchsal (DE)

(21) Appl. No.: 13/276,241

(22) Filed: Oct. 18, 2011

Related U.S. Application Data
(60) Provisional application No. 61/405,096, filed on Oct. 20, 2010.

(30) Foreign Application Priority Data
Jan. 5, 2011 (EP) 11 150 173.0

(51) Int. Cl. F03B 13/08; F15B 1/027

(52) U.S. Cl. 290/54; 60/398

(57) ABSTRACT

A method of operating and a pump storage arrangement are disclosed. The arrangement includes a main flow machine arranged between an energy store and an energy sink such that a fluid medium is conveyed out of the energy sink through the main flow machine into the energy store during pump operation while converting electrical energy into kinetic flow energy. The fluid medium is conveyed out of the energy store through the flow machine back into the energy sink during turbine operation while converting the stored potential energy into electrical energy. An auxiliary flow machine is arranged in series with the main flow machine and a conversion means is provided such that the fluid medium is conveyable through the main flow machine and the auxiliary flow machine during pump operation and the fluid medium is only conveyable through the main flow machine during turbine operation.

The invention relates to a pump storage arrangement, to a method of operating a pump storage arrangement and to a pump storage hydropower plant in accordance with the preamble of the independent claims.

Pump storage hydropower plants, which have been known per se for many decades, are increasingly gaining importance with the increasing expansion of renewable energies since they currently represent the only technical solution with which very large quantities of electrical energy can be stored. There are namely times in power supply in which a great deal of electricity has to be available (peak demand), with the energy demand falling in the grid at other times and accordingly less power being demanded. On electricity surpluses in the grid, the electricity can be purchased relatively inexpensively on the market and the power station works in pump operation in that water is pumped from a lower elevation water reservoir, for example from a lower elevation river or lake, into a higher elevation reservoir, for example into an artificial lake. If, in contrast, a lot of power is required in the grid in the short-term, the pump storage hydropower plant works in turbine operation in that the water is guided back out of the higher elevation reservoir via a turbine to which a generator is connected into the lower elevation reservoir. The potential energy of the water being released in this process drives the turbine and thus the generator so that the electrical energy previously stored as potential energy can be converted back into electrical energy and can again be provided to the electricity grid for utilization. The regained electrical energy can then be sold at times of high power consumption at a price which is higher than the low purchasing price of the electrical energy with which the upper reservoir was previously filled with water in pump operation.

The pump storage hydropower plants thus have a particular importance for forms of electrical energy acquisition in which the quantity of energy which can be generated cannot quickly be regulated from a high level to a lower level or vice versa, such as is the case with conventional power plants. Load changes in the electricity grid which cannot be implemented fast enough by the power plant can be compensated very easily with the help of pump storage hydropower plants.

The use of pump storage hydropower plants even has special advantages when the generated electrical energy is not available uniformly or not at exactly predictable times. This is a problem with which one is above all confronted with renewable energies such as the acquisition of electrical energy from solar energy or wind energy. The problem with wind energy is that the electrical energy fed into the electricity grid can fluctuate greatly in dependence on time because the quantity of generated electrical energy naturally directly depends on the strength of the solar radiation or of the prevailing winds.

If therefore a very large amount of energy is required at peak load times, the water is conducted from the upper reservoir via an intake and via pressure pipelines into a turbine building where it drives a turbine which is in turn connected to a generator which converts the rotational energy of the turbine into electrical energy.

If, in contrast, too much electrical energy is available in the public electricity grid, e.g. in off-peak times, the pump storage hydropower plant works in the opposite manner. Instead of a power machine (turbine), a work machine (pump) is now used. The connected electrical machine now no longer works as a generator, but rather as an electric motor and so drives the pump which conveys water from the lower reservoir into the upper reservoir again for storing the electrical energy. It is known in this respect that different machines are used for the pump operation and for the turbine operation. Solutions are, however, also known in which one and the same fluid-flow machine is used as a pump in pump operation and as a turbine in turbine operation.

The efficiency of known pump storage hydropower plants lies between approximately 60% and 80%. This means that of that relatively inexpensive electrical energy which is initially required at off-peak times to pump water into the higher elevation reservoir around 70% of the energy can be reacquired again in turbine operation via the generator and can be sold at a corresponding profit.

In times in which more and more electrical energy is required and in which, not least for environmental protection reasons, a particularly efficient handling of electrical energy is becoming more and more important, the demand, is also becoming louder and louder to improve the efficiency of pump storage hydropower plants and also to simplify the construction as much as possible.

As regards the conversion of kinetic flow energy into electrical energy and vice versa, two different solution approaches are substantially known, as already mentioned: either pumps optimized for pump operation are used for pumping and turbines ideally designed for turbine operation are used for reacquiring the electrical energy or one and the same flow machine is used for pump operation and for turbine operation.

Both variants have respective advantages and disadvantages.

The basic problem is namely that a flow machine can generally not easily be simultaneously optimized for turbine operation and pump operation. As the skilled person knows, a flow machine in particular has to be adapted in construction to the parameters delivery head or drop head H and conveying quantity Q, which are often fixedly defined in tight limits in practice. For general technical reasons known to the skilled person, it is in this respect regrettably the case that, if a flow machine is optimized for a specific delivery head H and a specific conveying quantity Q, the same flow machine is not suitable for turbine operation, and vice versa.

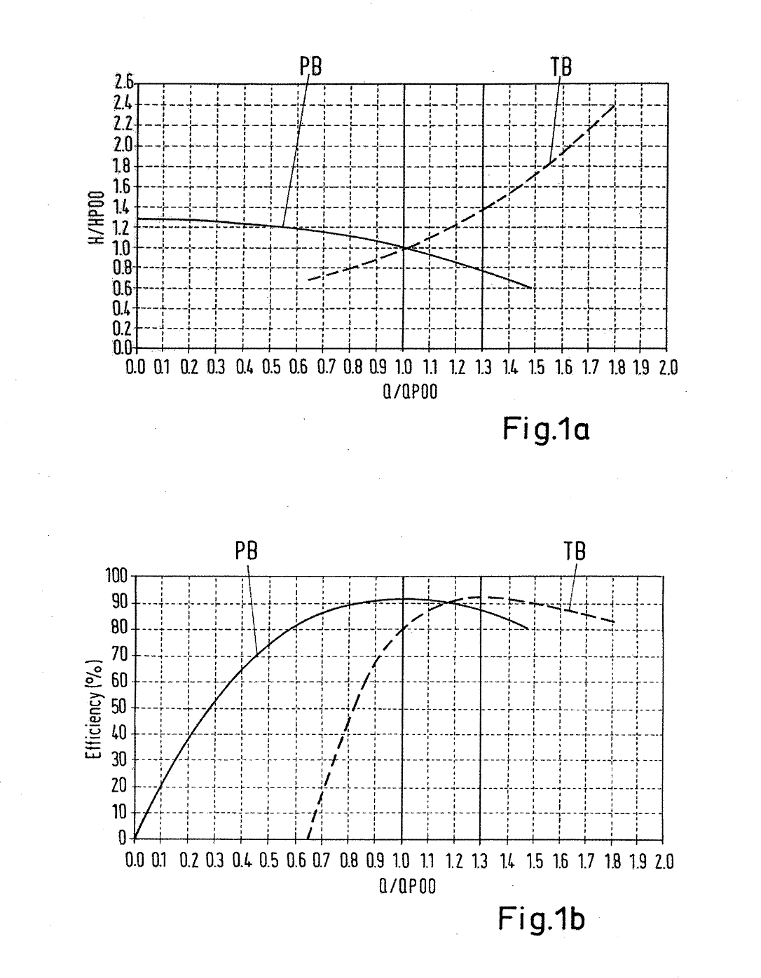

This fact which is known per se is illustrated again as a reminder with reference to FIG. 1a and FIG. 1b. In this respect, FIG. 1a shows the standardized delivery head/drop head characteristic for one and the same flow machine in pump operation PB (solid line) and in turbine operation TB (dashed line) which, as FIG. 1b shows, was optimized to pump operation. In this respect, in both Figures, the standardized conveying quantity Q/QP00 is entered on the abscissa, where Q is the conveying quantity and QP00 is the conveying quantity at the point of ideal efficiency in pump operation.

In FIG. 1a, the standardized delivery head H/HP00 is entered on the ordinate, where H is the delivery head or drop head and HP00 is the delivery head at the point of ideal efficiency in pump operation.

The efficiency is entered on the ordinate in FIG. 1b.

As can clearly be seen from FIG. 1b, the flow machine in accordance with FIG. 1a is optimized to an ideal efficiency for the operating state [H/HP00, Q/QP00]=[1, 1] in pump operation PB. The maximum of the efficiency curve for pump operation in the operating state is [H/HP00, Q/QP00]=[1, 1]. This means the flow machine is ideally designed for pump operation PB.

This necessarily has the consequence that, if this flow machine optimized for pump operation PB is operated in turbine operation TB, the flow machine does not run at its ideal efficiency when working as a turbine. The optimized efficiency in turbine operation TB would be at approximately Q/QP00=1.3 in accordance with FIG. 1b, that is far away from the ideal value for pump operation which is at Q/QP00=1 in accordance with FIG. 1b.

To avoid this problem, it is known, for example, to provide the flow machines with adjustable elements such as adjustable impellers and/or adjustable guide vanes. It is possible by such measures to set the flow machine to the ideal efficiency in the respective operating state. Such constructions are, however, complex and expensive and above all prone to disturbances and very service-intensive.

A double machine set composed of a pump and a turbine, which are respectively optimized for pump operation and turbine operation, is therefore normally provided. The pump is then only used for pump operation and the turbine only for turbine operation, with both machines naturally having to produce the full required performance so that a double set of flow machines has to be provided.

In this respect, there is still a further problem of a very different kind with the known plants. A pump requires a specific nominal input pressure at the pump inlet called the “net positive suction head” or NPSH in short, which may not be fallen below since otherwise gas bubbles can occur in the medium to be pumped during pumping, whereby the pumping can be made impossible in the worst case or the pump can be seriously damaged by huge pressure fluctuations or throughflow fluctuations.

This required net positive suction head, which is a minimum inlet pressure, is essentially fixed by the construction design of the pump and by the speed, with the construction design and the required speed of the pump in turn being largely defined by the marginal conditions of conveying quantity and delivery head which are as a rule hardly influenceable in the case of pump storage hydropower plants because the height difference between the lower and upper water reservoirs is, for example, fixed by the available terrain and the required conveying quantity or performance is also defined.

The aforesaid marginal conditions thus ultimately determine the required net positive suction head NPSH which must be applied at the inlet of the pump.

This has the consequence that the pumps often have to be provided at greater depth below the lowest possible water level of the lower water reservoir so that the required net positive suction head NPSH is always applied at the pump inlet. Since the net positive suction head NPSH is substantially proportional to the square of the speed of the pump, a high net positive suction head NPSH results at high pump speeds, which in turn requires a deep installation of the pump, which is naturally complex and/or expensive on the construction side.

On the other hand, the power density of the pump, which is defined as the product of the conveying quantity per second and the pumping height, is dependent on the speed and on the rotor diameter of the pump. As explained above, the required power density of the pump is defined by the marginal conditions. With a given power density, essentially two parameters are thus available to set the pump to the required power density. If a pump with a small rotor diameter is selected, the pump must have a high speed, which has the result that, as explained above, a high net positive suction head is required and the pump must be installed sufficiently low with respect to the lowest possible water level of the lower reservoir.

Such a fast rotating pump has the advantage that it can be designed as small in construction, whereby the pump can be manufactured more inexpensively and is naturally also more space saving than a large pump. This advantage is, however, lost again in that the pump has to be installed deep, which drives the construction costs up hugely.

If, in contrast, a relatively large pump with a large rotor diameter is selected, the required power density can be achieved with a lower speed. This has the advantage that the pump can be installed higher than a fast-running pump because the required net positive suction head is lower. This advantage is, however, acquired at the cost of the construction size of the pump. A large pump is naturally more expansive in manufacture and in operation.

It is therefore the object of the invention to avoid the problems known from the prior art and to provide a pump storage arrangement which is simultaneously optimized to turbine operation and to pump operation and which ensures a largest possible flexibility in the selection of the pump size and of the pump speed. It is furthermore an object of the invention to set forth a method of operating a pump storage arrangement as well as a corresponding pump storage hydropower plant.

The subject matters of the invention satisfying these objects are characterized by the features of the independent claims 1, 9 and 14.

The dependent claims relate to particularly advantageous embodiments of the invention.

The invention thus relates to a pump storage arrangement including an energy store and an energy sink, with a main flow machine being formed and arranged between the energy store and the energy sink such that a fluid medium is conveyable out of the energy sink through the main flow machine into the energy store while converting electrical energy into kinetic flow energy in a pump operation and is storable at a definable stored potential energy. In a turbine operation, the fluid medium is conveyable out of the energy store through the flow machine into the energy store while converting the stored potential energy back into electrical energy. In accordance with the invention, an auxiliary flow machine is arranged in series to a main flow machine in a flow train and a conversion means is provided such that the fluid medium is conveyable through the main flow machine and through the auxiliary flow machine in pump operation and the fluid medium is only conveyable through the main flow machine in turbine operation.

It is thus essential for the operation that the fluid medium is conveyable through the auxiliary flow machine and the main flow machine arranged in series from the energy sink into the energy store in pump operation. And in turbine operation, the fluid medium is conveyable out of the energy store only through the main flow machine back into the energy sink in that the fluid medium is conveyable through the conversion means past the auxiliary flow machine in turbine operation.

It is thus possible to design the auxiliary flow machine and the main flow machine such that the serial arrangement of the auxiliary flow machine and of the main flow machine is optimized overall for pump operation, with the main flow machine alone simultaneously being optimized for turbine operation.

This can be effected in practice, for example, in that first the main flow machine is designed so that it can be operated at its optimum efficiency in turbine operation. This has the consequence that the main flow machine designed in this manner is alone then no longer operable at its optimum efficiency in pump operation. This defect is remedied in that the auxiliary flow machine is additionally switched in series to the main flow machine for pump operation. The auxiliary flow machine is then selected so that the efficiency or the NPSH value of the combination of auxiliary flow machine and main flow machine is optimized for pump operation.

It has thus become possible for the first time by the invention to provide a machine set whose efficiency is optimized both for pump operation and for turbine operation, and indeed without adjustable elements such as adjustable impellers and/or adjustable guide vanes having to be provided at the machines which have the initially described disadvantages.

It is also not necessary to provide a complete double machine set composed of a pump and a turbine which are each optimized for pump operation and for turbine operation and have both correspondingly to be designed for the full pump performance and/or turbine performance. In the invention, a relatively small auxiliary flow machine in the form of an additional pump has to be provided only for pump operation.

In an embodiment of the present invention particularly important for practice, the pump storage arrangement is used in a pump storage hydropower plant. The pump storage arrangement in accordance with the invention does not only develop a further substantial advantage in this application.

As already initially explained in detail, a pump requires a specific nominal input pressure, called a “net positive suction head”, NPSH in short, which may not be fallen below, at the pump inlet.

This required minimum input pressure is, as likewise already explained, essentially fixed by the construction design of the pump and by the speed, with the construction design and the required speed of the pump in turn being largely defined by the marginal conditions of conveying quantity and delivery head which are as a rule hardly influenceable in the case of pump storage hydropower plants because the height difference between the lower and upper water reservoirs is, for example, fixed by the available terrain and the required conveying quantity is also defined.

Since the arrangement for pumping in accordance with the invention now no longer only includes a flow machine, but at least two machines, namely the auxiliary flow machine and the main flow machine, there is additionally a very large flexibility as regards the adaptation of the pump arrangement to the net positive suction head available due to the relationships.

If, for example, the auxiliary flow machine is provided between the main flow machine and a lower water reservoir in a pump storage hydropower plant, the size and/or the speed of the auxiliary flow machine can be selected flexibly within wide limits with a defined power density, which is defined as the product of the conveying quantity per time unit and pump height and is dependent on the speed and on the rotor diameter of the pump, in that the main flow machine is suitably adapted accordingly to the selected auxiliary flow machine.

It is thus possible to select an auxiliary flow machine which is relatively small in construction and which nevertheless simultaneously has a comparatively low speed and thus a low net positive suction head so that the auxiliary flow machine can be provided without any great construction effort with respect to the lowest possible water level of the lower water reservoir without the pump having to be installed, as in the prior art, at a comparatively great depth with respect to the lower water reservoir. This becomes possible in that the auxiliary flow machine does not have to provide the total pump performance, but e.g. only provides 30% of the total pump performance.

In another embodiment, it is conversely also possible that the auxiliary flow machine is suitably adapted accordingly to the selected main flow machine.

A main flow machine comparatively small in construction can also be selected, with the auxiliary flow machine naturally also not having to produce the total pump performance, but can e.g. produce around 70% of the total pump power.

In a particularly preferred embodiment of the present invention, the auxiliary flow machine is arranged between the energy sink, that is, for example, between a lower water reservoir, and the main flow machine.

The main flow machine is in this respect particularly advantageously, but not necessarily, arranged between the main flow machine and the energy store.

In practice, for example on a use of the pump storage arrangement in a pump storage hydropower plant, up to 50% of the pump height of the main flow machine, preferably between 10% and 40%, particularly preferably approximately 30%, of the pump height of the main flow machine can be achieved, for example, with the auxiliary flow machine in the operating state.

In this respect, the auxiliary flow machine can advantageously be a pump which has a smaller net positive suction head than the main flow machine.

In practice, a pump storage arrangement in accordance with the invention will often include a plurality of main flow machines and/or a plurality of auxiliary flow machines, with a plurality of flow trains, each including one or more auxiliary flow machines and one or more main flow machines, which can be particularly advantageously provided in a parallel arrangement, being able to be provided to increase performance.

In a pump storage hydropower plant, for example, in this respect the energy store can be a water reservoir, in particular a lake, disposed at an elevation and the energy sink can be a water reservoir, in particular a lake or a river, at a lower elevation than the energy store.

The invention further relates to a method of operating a pump storage arrangement including an energy store and an energy sink, with a main flow machine being arranged between the energy store and the energy sink such that a fluid medium can be conveyed out of the energy sink through the main flow machine into the energy store while converting electrical energy into kinetic energy in a pump operation and is stored at a definable stored potential energy in the energy store. In this respect, in a turbine operation, the fluid medium is conveyed out of the energy store through the flow machine back into the energy sink while converting the stored potential energy into electrical energy. In accordance with the invention, an auxiliary flow machine is arranged in series to the main flow machine in a flow train and a conversion means is provided such that the fluid medium is conveyed through the main flow machine and through the auxiliary flow machine in pump operation and the fluid medium is only conveyed through the main flow machine in turbine operation

In this respect, in a preferred embodiment, the fluid medium, in particular water, is supplied by means of the auxiliary flow machine out of the energy sink to the main flow machine and the main flow machine conveys the fluid medium on into the energy store.

The main flow machine and the auxiliary flow machine are particularly advantageously designed so that up to 50% of the pump height of the main flow machine, preferably between 10% and 40%, particularly preferably approximately 30%, of the pump height of the main flow machine is achieved with the auxiliary flow machine in the operating state.

In practice, in this respect, a pump is frequently used as the auxiliary flow machine which has a smaller net positive suction head than the main flow machine.

To increase the performance, a plurality of main flow machines and/or a plurality of auxiliary flow machines can be provided, with the plurality of main flow machines and/or the plurality of auxiliary flow machines preferably being able to be provided in a plurality of flow trains, in particular in a parallel arrangement.

Finally, the invention relates to a pump storage hydropower plant, including a pump storage arrangement, which can be operated in accordance with a method of the invention.

The invention will be explained in more detail in the following with reference to the drawing. There are shown in a schematic representation:

FIG. 1a a standardized delivery head/drop head characteristic for one and the same flow machine in pump operation and turbine operation;

FIG. 1b an efficiency characteristic for the pump operation and

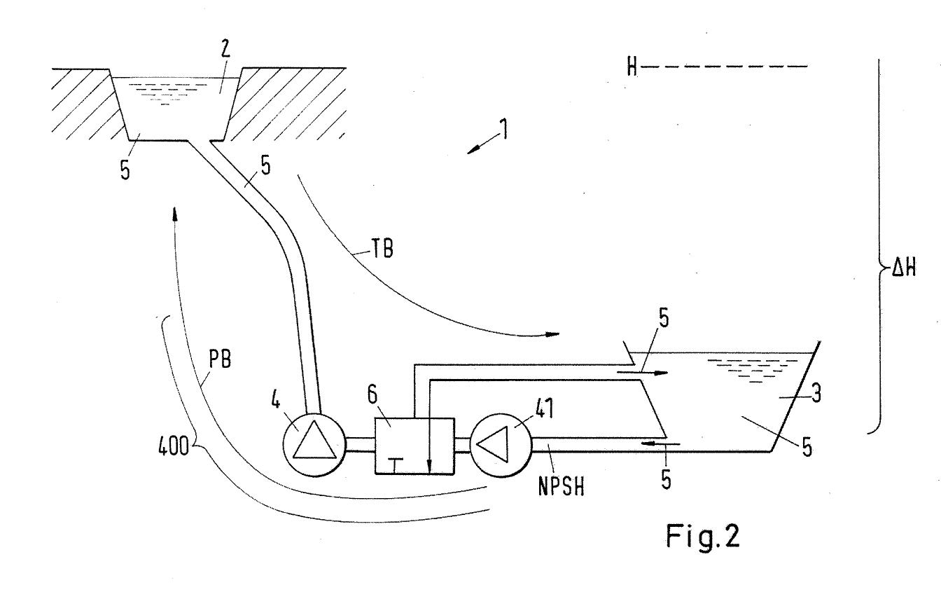

FIG. 2 a pump storage hydropower plant in accordance with the invention.

The characteristic line known per se of a flow machine for the pump operation and turbine operation in accordance with FIG. 1a and FIG. 1b have already initially been discussed in detail.

FIG. 2 shows in a simplified schematic representation a pump storage hydropower plant in accordance with the present invention.

The pump storage hydropower plant of FIG. 2 includes a pump storage arrangement 1 in accordance with the invention having an energy store 2 which is here an artificial lake located on a hill of a height H as well as an energy sink 3 which is a river disposed lower than the energy store 2 by the height difference ΔH. A main flow machine 4 is formed and arranged between the energy store 2 and the energy sink 3 such that a fluid medium 5, here water, is conveyable out of the energy sink 3 through the main flow machine 4 into the energy store 2 in pump operation PB while converting electrical energy into kinetic flow energy and is storable in the upper artificial lake at a predefinable stored potential energy. Conversely, in turbine operation TB, the fluid medium 5 is conveyable out of the energy store 2 through the flow machine 4 back into the energy sink 3 while converting the stored potential energy into electrical energy.

In contrast to the prior art, in the present invention, an auxiliary flow machine 41 at whose inlet the net positive suction head NPSH is applied is arranged in a flow train 400 in series with the main flow machine 4 and a conversion means 6 is provided such that the fluid medium 5 is conveyable through the main flow machine 4 and the auxiliary flow machine 41 in pump operation PB and the fluid medium 5 is only conveyable through the main flow machine 4 in turbine operation TB.

For reasons of clarity, the explicit representation of the electric machines, one of which drives the main flow machine 4 and the auxiliary flow machine 41 as a motor in pump operation TB and one of which converts the kinetic flow energy back into electrical energy again as a generator in turbine operation TB was omitted. The aforesaid electric machines are mechanically coupled in a manner known per se and in a function known per se to the main flow machine 4 and the auxiliary flow machine 41, on the one hand, and are electrically coupled to the public electric grid, on the other hand, so that kinetic flow energy of the fluid 5 and electrical energy from the public electric grid can be converted into one another and are thus exchangeable via the flow machines 4, 41 and the electric machines.

The auxiliary flow machine 41 is in this respect arranged between the energy sink 3 and the main flow machine 4 which is in turn arranged between the auxiliary flow machine 41 and the energy store 2. In the example in accordance with the schematic FIG. 2, roughly approximately 30% of the pump height of the main flow machine 4 can be achieved with the auxiliary flow machine 41, with the auxiliary flow machine 41 being a pump which has a smaller net positive suction head NPSH than the main flow machine 4.

In practice, the pump storage arrangement 1 will include a plurality of main flow machines 4 and/or a plurality of auxiliary flow machines 41, with the representation of further flow trains 400, which can in particular be provided in parallel arrangement, being omitted in FIG. 2 for reasons of clarity.

A plurality of problems known from the prior art are thus simultaneously solved for the first time by the invention which were above all long unsolved in pump storage hydropower plants. The pump storage arrangement in accordance with the invention is simultaneously optimized to pump operation and to turbine operation. In addition, the problem with too high a net positive suction head is solved in that that machine, as a rule the auxiliary flow machine, which pumps the water directly out of the lower water reservoir only has to produce a fraction of the pump performance required overall. The construction costs can thereby be considerably lowered since the auxiliary flow machine no longer has to be installed at a great depth with respect to the lowest possible water level of the lower water reservoir since the power density, i.e. essentially the speed and the construction size of the auxiliary flow machine and thus the minimum inlet pressure, is freely selectable within wide limits and can be adapted to the specific relationships.

It is understood that all the above-described embodiments of the invention are only to be understood as examples or by way of example and that the invention in particular, but not only, includes all suitable combinations of the described embodiments.

1. A pump storage arrangement, including an energy store (2) and an energy sink (3), wherein a main flow machine (4) is formed and arranged between the energy store (2) and the energy sink (3) such that a fluid medium (5) is conveyable out of the energy sink (3) through the main flow machine (4) into the energy store (2) in a pump operation (PB) while converting electrical energy into kinetic flow energy and is storable at a predefinable stored potential energy, and wherein the fluid medium (5) is conveyable out of the energy store (2) through the flow machine (4) back into the energy sink (3) in a turbine operation (TB) while converting the stored potential energy into electrical energy,
characterized in that an auxiliary flow machine (41) is arranged in a flow train (400) in series with the main flow machine (4) and a conversion means (6) is provided so that the fluid medium (5) is conveyable through the main flow machine (4) and the auxiliary flow machine (41) in pump operation (PB) and the fluid medium (5) is only conveyable through the main flow machine (4) in turbine operation (TB).

2. A pump storage arrangement in accordance with claim 1, wherein the auxiliary flow machine (41) is arranged between the energy sink (3) and the main flow machine (4).

3. A pump storage arrangement in accordance with claim 1, wherein the main flow machine (4) is arranged between the main flow machine (41) and the energy store (2).

4. A pump storage arrangement in accordance with claim 1, wherein up to 50% of the pump height of the main flow machine (4), preferably between 10% and 40%, particularly preferably approximately 30%, of the pump height of the main flow machine (4) can be achieved with the auxiliary flow machine (41) in the operating state.

5. A pump storage arrangement in accordance with claim 1, wherein the auxiliary flow machine (41) is a pump which has a smaller net positive suction head (NPSH) than the main flow machine (4).

6. A pump storage arrangement in accordance with claim 1, wherein a plurality of main flow machines (4) and/or a plurality of auxiliary flow machines (41) are provided.

7. A pump storage arrangement in accordance with claim 1, wherein a plurality of flow trains (400) are provided, in particular in a parallel arrangement.

8. A pump storage arrangement in accordance with claim 1, wherein the energy store (2) is a water reservoir, in particular a lake, disposed at a height (H) and the energy sink is an energy store (2), in particular a lake or a river, disposed lower by the height difference (AH).

9. A method of operating a pump storage arrangement (1), including an energy store (2) and an energy sink (3) wherein a main flow machine (4) is arranged between the energy store (2) and the energy sink (3) such that a fluid medium (5) is conveyed out of the energy sink (3) through the main flow machine (4) into the energy store (2) in a pump operation (PB) while converting electrical energy into kinetic flow energy and is stored at a predefinable stored potential energy, and wherein the fluid medium (5) is conveyed out of the energy store (2) through the flow machine (4) back into the energy sink (3) in a turbine operation (TB) while converting the stored potential energy into electrical energy,
characterized in that an auxiliary flow machine (41) is arranged in a flow train (400) in series with the main flow machine (4) and a conversion means (6) is provided such that the fluid medium (5) is conveyed through the main flow machine (4) and the auxiliary flow machine (41) in pump operation (PB) and the fluid medium (5) is only conveyed through the main flow machine (4) in turbine operation (TB).

10. A method in accordance with claim 9, wherein the fluid medium (5), in particular water, is supplied to the main flow machine (4) out of the energy sink (3) by means of the auxiliary flow machine (41) and the main flow machine (4) conveys the fluid medium (5) into the energy store (2).

11. A method in accordance with claim 9 or claim 10, wherein up to 50% of the pump height of the main flow machine (4), preferably between 10% and 40%, particularly preferably approximately 30%, of the pump height of the main flow machine (4) is achieved with the auxiliary flow machine (41) in the operating state.

12. A method in accordance with claim 9, wherein a pump which has a smaller net positive suction head (NPSH′) than the main flow machine (4) is used as the auxiliary flow machine (41).

13. A method in accordance with claim 1, wherein a plurality of main flow machines (4) and/or a plurality of auxiliary flow machines (41) are provided, wherein the plurality of main flow machines (4) and/or the plurality of auxiliary flow machines (41) are preferably provided in a plurality of flow trains (400), in particular in a parallel arrangement.

14. A pump storage hydropower plant including a pump storage arrangement (1) in accordance with claim 1 which is operable in accordance with a method in accordance with claim 9.
